(19) United States
(12) Patent Application Publication
(10) Pub. No.: US 2012/0168096 A1
(43) Pub. Date: Jul. 5, 2012

(54) DEVICE FOR ASSISTING THE INSTALLATION AND DE-INSTALLATION OF AN AWNING

(76) Inventors: Xian Wei LI, Hangzhou (CN); Li Zheng, Wenling (CN)

(21) Appl. No.: 13/344,004

(22) Filed: Jan. 5, 2012

(30) Foreign Application Priority Data
Jan. 5, 2011 (EP) 11150255.5

(51) Int. Cl. B23P 19/04; E04F 10/02

(52) U.S. Cl. 160/127; 29/728

(57) ABSTRACT

The invention relates to a device (22, 42, 72) for assisting the installation and de-installation of an awning (19) at an awning rail (16); the device (22, 42, 72) has a connecting element (40, 73-75) for connection with the awning (19) and a motor (38, 62) for moving the edge of the awning (19) along the awning rail (16);
the device (22, 42, 72) comprises a sliding body (25, 45) for sliding the device (22, 42, 72) along the awning rail (16) in a sliding direction; the motor (38, 62) is located on or in the sliding body (25, 45);
a driving wheel (26, 46) is disposed on the sliding body (25, 45) and is driven by the motor (38, 62) and arranged so that it contacts the outside of the awning rail (16) when the device (22, 42, 72) is placed on the awning rail (16).

### CROSS-REFERENCE TO RELATED APPLICATIONS AND CLAIM TO PRIORITY

This application is related to application No. 11 150 255.5, filed Jan. 5, 2011, in the European Patent Office, the disclosure of which is incorporated herein by reference and to which priority is claimed.

### FIELD OF THE INVENTION

The invention refers to a device for assisting the installation and de-installation of an awning at an awning rail fixed on a wall for example of a vehicle like a caravan, the awning rail having a C-profile with a slot extending in its longitudinal direction and being destined for the reception of a beading provided at an edge of the awning. The device has a connecting element for connection with the awning and a motor for moving the edge of the awning along the awning rail, wherein the motor is combined with a control system for starting and stopping the motor.

### BACKGROUND OF THE INVENTION

In general, awnings consist of tent-like structures made of flexible material such as canvas or plastics material. They are particularly used by caravaners to extend the living space or the usable space of a caravan or motor home or a similar vehicle.

To compensate for the lack of space available in the vehicle, caravaners typically install an awning at that side wall of the vehicle, where the vehicle door is situated. The awning typically has a roof and three covered side walls. The forth side is open and intended to face the wall, where the door is situated. For attaching the awning to the vehicle, these vehicles are provided with an awning rail consisting of a C-profile with a slot extending in its longitudinal direction. This awning rail is fixed at the edge formed at the connection of one of the side walls with the rear, roof and front walls of the vehicle.

The edge of the open side of the awning is provided with a cord like beading, the diameter of which is bigger than the width of the slot of the C-profile and smaller than the cross section of the channel enclosed by the awning rail. For fitting the awning rail to the vehicle, one end of the beading is inserted into one end opening of the awning rail and pushed at first upwardly, than sidewards along the roof wall and finally downwards until its end. Simultaneously it is usually required to pull the beading from its opposite end. De-installation may be performed by reversing the foregoing operation.

For installation and de-installation of the awning, working of two persons is required. One person performs inserting and feeding of the beading into the opening end of the awning rail, while the other person is pulling the beading from the opposite end along the awning rail. To support and to simplify this work, it is suggested in GB 2 341 351 A, GB 2 271 089 A and EP 1 514 983 A1 to provide a pull cord system comprising a pull cord, which is inserted into and extending along the awning rail and is connected at one end with a winch like reel, on which the pull cord can be coiled up and uncoiled. The other end of the pull cord can be connected with one end of the beading of the awning. By coiling up the pull cord onto the reel, the beading is drawn along the awning rail. The reel can be operated by hand or by means of an electrical motor.

A similar suggestion is disclosed in EP 2 256 270 A1. According to this suggestion, the pull cord system should have a pull cord capable of transmitting both pulling and pushing forces, i.e. it should be sufficiently rigid for allowing the beading to be pulled during installation and pushed during de-installation. However, the disadvantages are the same as on the pull cord systems disclosed in the other cited publications. The pull cord has to be fitted for every installation process and afterwards removed or has to remain in the awning rail subjecting the cord to environmental influences such as rain water, dust etc. Moreover, pull cord systems are susceptible for jamming in the awning rail or even for brake down.

Moreover, a pull cord can only transmit pulling forces because they are not so stiff and rigid enough for transmitting pushing forces, which enables de-installation of the awning. If the pull cord is rigid enough for allowing pushing the beading along the awning rail, the pull cord has a strong resistance against bending in the curves of the awning rail causing high friction and against coiling up on the reel. The reel and the electrical motor are mounted on the outside of the vehicle and therefore are subject to environmental influences, even if they are covered by a dust proof housing as suggested in EP 2 256 270 A1. In any case, the housing has an opening for entrance of the pull cord, and this opening cannot be closed, if the pull cord remains in the awning rail during driving the vehicle.

### SUMMARY OF THE INVENTION

Therefore, it is an object of the invention to provide a device, which simplifies the installation and de-installation of an awning to and from an awning rail, is not susceptible to jamming in the awning rail and can be protected against detrimental environmental influences.

Another object is to provide a combination of this device with an awning rail and also a caravan provided with that combination.

The first part of this object is solved in accordance with the invention by a device, which is characterized in that the device comprises a sliding body for sliding the device along the awning rail in a sliding direction, that a driving wheel is disposed on the sliding body with a rotation axis perpendicular to the sliding direction and driven by the motor and that the driving wheel is arranged so that it contacts the outside of the awning rail, when the device is placed on the awning rail.

The basic idea of this invention is that a device is provided having a sliding body, which can be moved along the awning rail by means of a driving wheel driven by the motor and located on or in the sliding body. For installation of an awning, the device connected with the awning at one end of the beading is placed on one end of the awning rail. Then, the motor is actuated so that the device is moved along the awning rail drawing the beading of the awning through the awning rail. It is only one person required for assisting this operation by guiding the beading at the entrance of the awning rail in order to avoid jamming. If the beading is in its end position, the device can be disconnected from the awning and can be easily removed from the awning rail for safe stowing in the vehicle. De-installation may be performed by reversing the above operation, i.e. the device is again installed at the awning rail and is connected with this end of the awning. By actuating the motor, the end of the beading and hence, the entire beading is pushed back through the awning rail, until the end of the beading has left the rail. Thereafter, the device can be removed from the awning rail again and stowed away.

Due to the foregoing description, it is recognizable that the device according to the present invention is easy to handle and that installation and de-installation of the awning can be carried out by only one person. Having completed installation or de-installation of the awning, the device can be removed from the awning rail and hence, be protected by stowing away to a safe location.

According to an embodiment of the invention, at least one guiding element projects from the sliding body and is embodied so that the at least one guiding element is partly insertable into the interior of the awning rail, the sliding body being outside the awning rail. The at least one guiding element retains the entire device on the awning rail safely and assists contact between the driving wheel and the awning rail. It is preferable, that the at least one guiding element comprises at least one guiding wheel or guiding ball, particularly having a rotation axis extending perpendicularly to the sliding direction and being adapted to be inserted into the awning rail. Due to this embodiment, the sliding resistance of the device is very low, because the sliding body is supported only by turning elements, i.e. by the rotating guiding wheels or balls on the one hand and by the rotating driving wheel on the other hand. Preferable the rotation axis of the driving wheel and the rotation axis of the at least one guiding wheel has parallel extensions.

In accordance with another suggestion of the invention, the at least one guiding element has a guiding bar adapted to project through the slot of the C-profile and extending between the sliding body and that part of the at least one guiding element destined to be inserted into the awning rail. The guiding bar supports in connection with the edges of the slot an exact guiding of the device along the awning rail. The guiding bar should have an extension perpendicular to the sliding direction, which is only slightly smaller than the width of the slot of the awning rail.

For an exact guiding of the device it is also advantageously that at least two guiding elements are provided so that at least one guiding element is located in sliding direction ahead of the driving wheel and at least one behind the driving wheel. This location of the guiding elements with respect to the driving wheel causes a triangular guiding of the device on the awning rail and provides a stable guiding during the movement of the device.

In another embodiment of the invention, it is suggested that the device comprises a pressing device destined for enforcing the driving wheel into pressing contact with the outside of the awning rail. This pressing device should ensure that the driving wheel have enough grip to the awning rail to draw or push the beading through the awning rail independent of the dimension of the C-profile. So, it is not necessary to adapt the device and particularly the position of the driving wheel with regard to the specific awning rail, which the device should be placed on.

The pressing device can possess a spring mechanism pressing the driving wheel against the outside of the awning rail, when the device is placed on the awning rail. In one embodiment the pressing device comprises an adjusting device for displacement of that part of the at least one guiding element destined to be inserted into the awning rail to and from the driving wheel and/or for displacement of the driving wheel to and from that part of the at least one guiding element destined to be inserted into the awning rail. By this pressing device, the position of the driving wheel and that part of the at least one guiding element destined to be inserted into the awning rail can be adjusted by the user of the device in a wide range so that the device can be adapted and installed to awning rails with different cross sections.

In an alternative thereto, the pressing device comprises a pressing body having a counter wheel with a rotation axis extending parallel to the rotation axis of the driving wheel and that the two wheels extend in the same plane and are disposed so that their distance is adjustable by a pressing mechanism for pressing the two wheels towards opposite side walls of the awning rail, when the device is placed on the awning rail. By this embodiment, the device is supported on the awning rail by two opposite wheels which are disposed so that they contact the awning rail on both side walls. By reducing the distance between the rotation axises of these wheels, the pressure between the driving wheel and the awning rail can be adjusted so that there is enough grip for drawing or pushing the awning along the awning rail. This embodiment of the device can be combined with the at least one guiding element as described above.

However, guiding elements projecting into the interior of the awning rail are not necessary, if the connecting element for connecting the device with the awning is located at the front end of the device so that the device is retained on the awning wheel by the beading drawn or pushed by the device. In this case, the beading of the awning forms a guiding element keeping the sliding body on the awning rail in a position, wherein it is able to slide along the awning rail. In combination therewith or in connection thereto, the device can comprise a clamping mechanism for clamping the awning nearby the beading. The clamping mechanism ensures that the sliding body cannot leave the awning rail.

It is not necessary that a reversible motor is used for the device, because the device can be mounted at one end of the awning rail with a driving direction in the extension of the awning rail and on the other end of the awning rail after having turned about 180°, so that also then the driving direction concurs with the extension of the awning rail. However, it is advantageously to have a motor, the driving direction of which is reversible, because then it does not matter, in which position the device is mounted on the awning rail. Moreover, it is than possible to change the driving and hence the moving direction of the device during an installation or de-installation operation, for example if jamming of the beading occurs or if the intension to fit or remove the awning changes during that operation.

For controlling the motor of the device it may be sufficient to have an electrical cable connection from the motor to a control switch, which can be hand- or foot-actuated. In this case, the electrical cable should be so long that the user can place the control switch in a position nearby that end of the awning rail, where the user is supporting insertion or leaving of the beading into or from the awning (see GB 2 271 089 A). In an alternative, the control system comprises a remote control enabling to control the motor via wireless control signals as disclosed in EP 2 256 270 A1. A remote control avoids an electrical cable, which could get entangled with the awning during the installation or de-installation operation.

It is recommended that the motor is an electrical motor connectable with an electrical energy source. This energy source may be a battery or an accumulator, which should preferable rechargeable. That energy source can be located on the sliding means, preferable removable mounted for recharging. In an alternative, the motor can be connected with the battery of the vehicle by an electrical cable.

The connecting element for connecting the device with the edge of the awning should be adapted to the connecting element at the awning so that easy coupling of both connecting elements can be effected. For example, the connecting element of the device can be embodied as a hook, if the connecting element of the awning is embodied as an eye. If the motor is not reversible, two connecting elements should be provided at both ends of the device so that connection with the awning is possible also in a turned position of the device.

The second part of the object of the invention is solved by a combination of an awning rail with the foregoing described device for the installation and de-installation of an awning, the awning rail having a C-profile with a slot extending in its longitudinal direction, the C-profile being destined for the reception of the beading at an edge of the awning, wherein the device is installable or installed at the awning rail with the sliding body being outside of the awning rail and the driving wheel being pressed against the outside of the awning rail. Particularly at least one guiding element projects from the sliding body through the slot of the awning rail to its inside, so that the at least one guiding element is partly inserted into the interior of the awning rail.

Preferably the device should comprise a pressing device for enforcing the driving wheel into pressing contact with the awning rail. As described above, the pressing device may be embodied as an adjusting device enabling to displace that part of the at least one guiding element being inside of the awning rail to and from the driving wheel and/or to displace the driving wheel to and from that part of the at least one guiding element being inside of the awning rail. As an alternative thereto, the pressing device comprises a pressing body having a counter wheel with a rotation axis extending parallel to the rotation axis of the driving wheel and that the two wheels extend in the same plane and are disposed so that their distance is adjustable by a pressing mechanism for pressing the two wheels towards opposite side walls of the awning rail.

Finally the invention refers to a caravan provided with a combination of a device and an awning rail as disclosed above. The item caravan should cover caravan trailers to be connected with a motor vehicle as well as motor homes having a room similar to a caravan trailer, but constituting a motor vehicle.

### BRIEF DESCRIPTION OF THE DRAWINGS

The present invention will be described, by way of examples only, with a reference to the accompanying drawings, in which:

FIG. 1 shows a side elevation of a caravan together with an awning at the beginning of an installation operation;

FIG. 2 shows a longitudinal cross-sectional view of a combination of an awning rail with a first embodiment of the device for assisting installation and de-installation of an awning;

FIG. 3 shows a cross-sectional view of the combination transverse to the view according to FIG. 2;

FIGS. 4 to 7 show cross-sectional views according to the view of FIG. 2, however with the device in different positions with respect to the awning rail;

FIG. 8 shows a cross-sectional view of a combination of an awning rail with a second embodiment of the device for assisting installation and de-installation of an awning in a plane transversely of the longitudinal axis of the awning rail;

FIG. 9 shows a longitudinal cross-sectional view of the combination according to FIG. 8;

FIG. 10 shows a cross-sectional view of a combination of an awning rail with a third embodiment of the device for assisting installation and de-installation of an awning transverse to the longitudinal axis of the awning rail;

FIG. 11 shows a longitudinal cross-sectional view of the combination according to FIG. 10;

FIG. 12 shows a longitudinal cross-sectional view of the combination transverse to the view according to FIG. 10, but in a plane turned about 90° with respect to the plane of the cross-section of FIG. 11.

### DETAILED DESCRIPTION OF THE PREFERRED EMBODIMENTS(S)

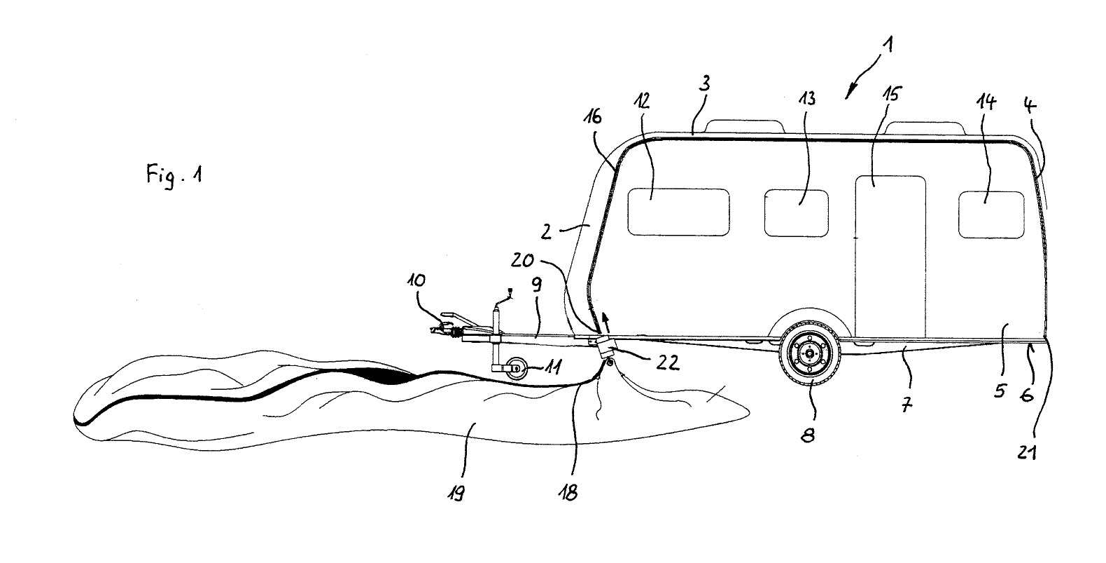

FIG. 1 of the drawings shows a typical caravan 1 having a housing formed by a front wall 2, a roof wall 3, a rear wall 4 and two vertical flat side walls 5, the one of which is visible in FIG. 1. The housing is deposited onto a bottom wall 6, which is resting on a frame 7. In the middle of the bottom wall 6, the frame 7 is suspended by an axis having a wheel 8 on each side. At the front end, the frame 7 continues to a draw bar 9 comprising a coupling 10, which is connectable to a towing vehicle such as a passenger car or a pickup truck (not shown). To the drawbar 9, an auxiliary wheel 11 is suspended vertically adjustable. It can be lowered for providing stability, when the caravan 1 is parking and raised when the caravan 1 is moving.

The side wall 5 is provided with windows 12, 13 and 14 and a door 15 between the windows 13, 14. An awning rail 16 is fixed along the edge of the side wall 5 beginning at a front location near the bottom wall 6, continuing upwardly to the roof wall 4, than rearwards along the roof wall 4 above the windows 12, 13, 14 and the door 15 towards the rear wall 4 and downwardly towards the rear end of the caravan 1 ending nearby the bottom wall 6 again. The awning rail 16 consists of a C-profile and is destined to receive and retain a beading 18 of an awning 19, which is in FIG. 1 spreaded out about the ground, which the caravan 1 is resting on. The awning rail 16 is open at its front end 20 and its rear end 21 so that the beading 18 can be introduced into one of these ends 20, 21 and also removed therefrom about these ends 20, 21.

It is recognizable in FIG. 1, that the awning 19 is connected with a device 22 at the end region of the beading 18. The device 22 is in a position near the front end 20 of the awning rail 16 for mounting the device 22 onto the awning rail 16 in the direction of the arrow. The device 22 is destined to assist a person who wants to install the awning 19 at the awning rail 16 in order to connect the awning 19 with the caravan 1.

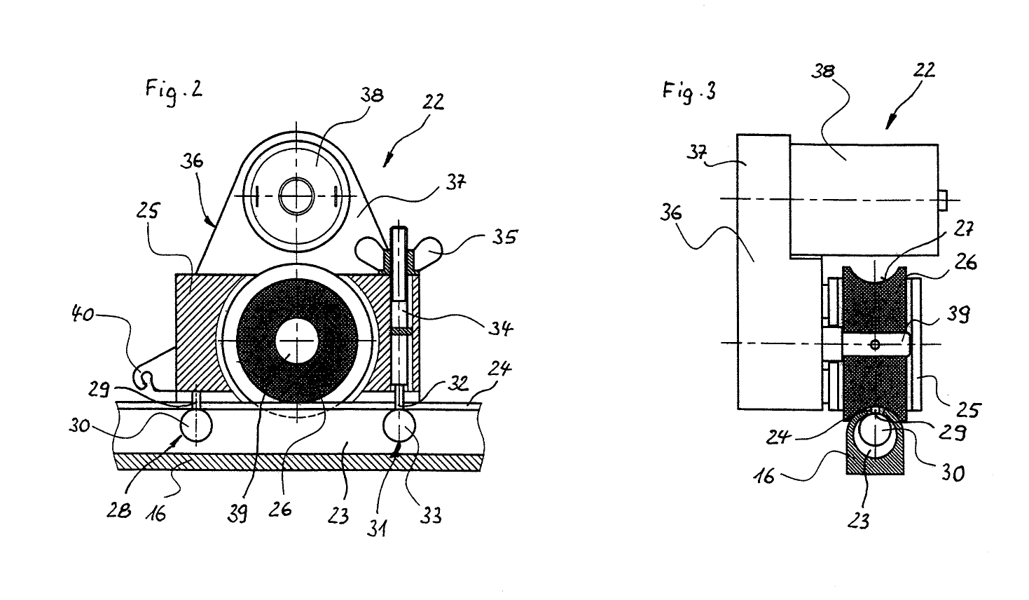

FIGS. 2 and 3 show a first embodiment of the device 22 mounted on the awning rail 16. As particularly recognizable in FIG. 3, the awning rail 16 encloses a free channel 23 with a round cross section, which is open to the outside about a small slot 24 extending in longitudinal direction of the awning rail 16 and constituting a C-profile. The device 22 comprises a sliding body 25 being outside of the awning rail 16. A driving wheel 26 is disposed within the sliding body 25 having a concave rolling surface 27 at its circumference, the radius of which is adapted to the radius of the outer surface of the awning rail 16. The driving wheel 26 consists of an elastomeric material like rubber, and its rolling surface 27 is in frictional contact with the outer surface of the awning rail 16.

At the rear end of the sliding body 25 and at its bottom, a first guiding element 28 is projecting from the sliding body 25 through the slot 24 into the channel 23 of the awning rail 16. The guiding element 28 consists of a guide bar 29 guided by the edges of the awning rail 16 forming the slot 24 and of a guiding ball 30 being in contact with the inside of the awning rail 16 on both sides of the slot 24. At the front end of the sliding body 25, a second guiding element 31 is provided projecting from the sliding body 25 through the slot 24 to the channel 23 of the awning rail 16. Also this guiding element 31 comprises a guide bar 32 extending through the slot 24 and a guiding ball 33 contacting the inside of the awning rail 16 on both sides of the slot 24.

Other than the guiding element 28, guiding element 31 is connected with a tie bolt 34 having an end part extending outside the sliding body 25 and having a screw thread, onto which a wing screw 35 is screwed, which is supported on the outside of the sliding body 25. By turning the wing screw 35, the tie bolt 34 and hence, the guiding element 31 can be adjusted in a direction vertically to the longitudinal axis of the channel 33 or the awning rail 16. If the wing screw 35 is turned so that the guiding element 31 is lifted up (in the view of FIGS. 2 and 3 upwardly), the sliding body 25 is turned about an axis extending transversely to the longitudinal axis of the awning rail 16 and located at the contact between the guiding ball 30 and the inner wall of the channel 31. Consequently the guiding ball 33 is pressed against the inner wall of the channel 23 and the driving wheel 26 is pressed against the outside of the awning rail 16, so that both guiding balls 30, 33 and the driving wheel 26 have pressing contact to the awning rail 16 providing the driving wheel 26 with enough grip contact for transmitting driving forces.

At one side of the sliding body 25, a gear box 36 is flange-mounted having an extension 37 above the sliding body 25, where an electrical motor 38 is fixed extending above the sliding body 25 and the driving wheel 26. The gear box 36 covers a gear connecting the driving axis of the motor 38 with a parallel axis 39 projecting from the gear box 36 into the sliding body 25. This axis 39 is connected with the driving wheel 26 fixedly so that the driving force of the motor 38 is transmitted via the gear and the axis 39 to the driving wheel 26. Consequently, by actuating the motor 38, the driving wheel 26 is driven so that the device 22 in its entirety is moved along the awning rail 16.

At the rear end of the sliding body 25, a hook 40 is fixed for engagement with an eye provided in the end region of the beading of the awning 19.

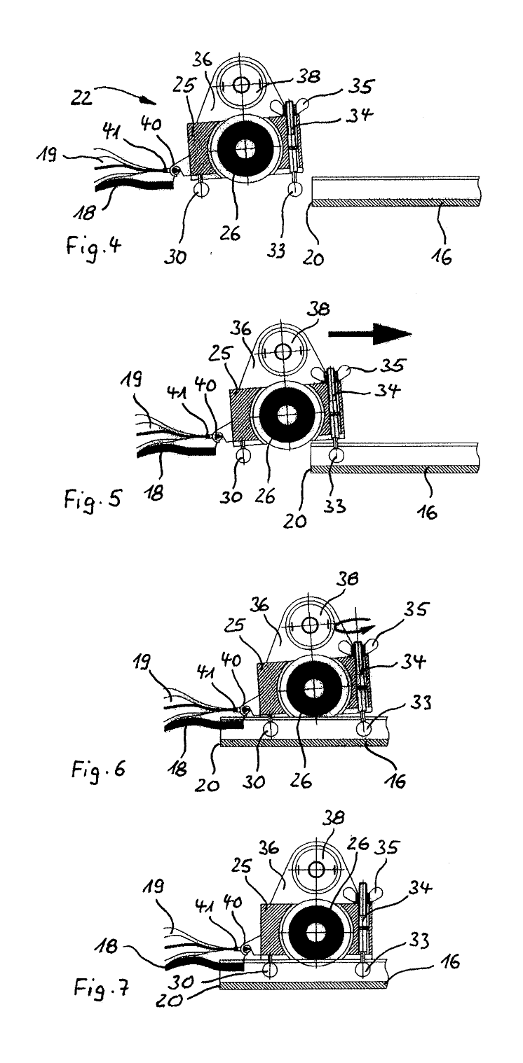

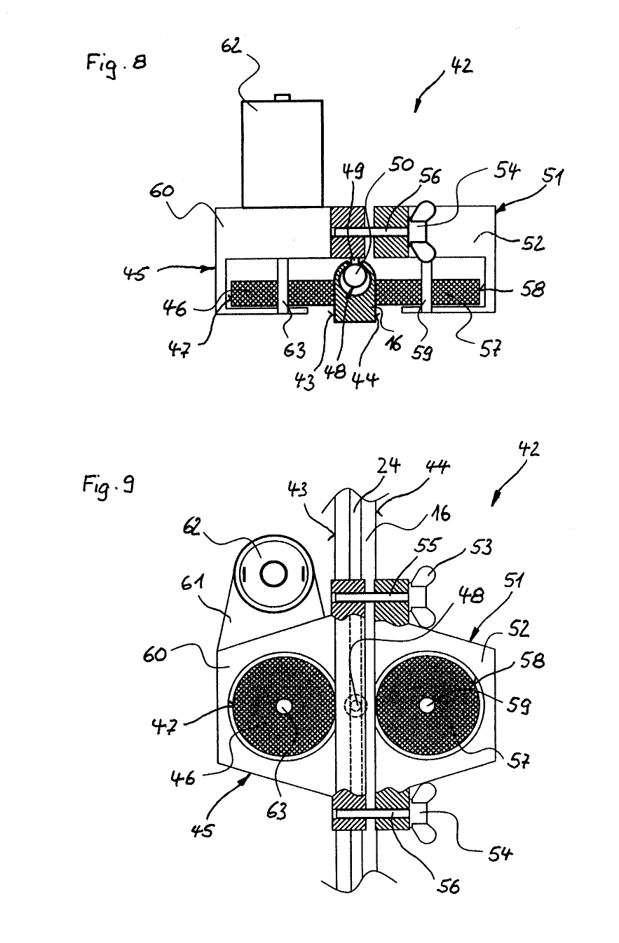

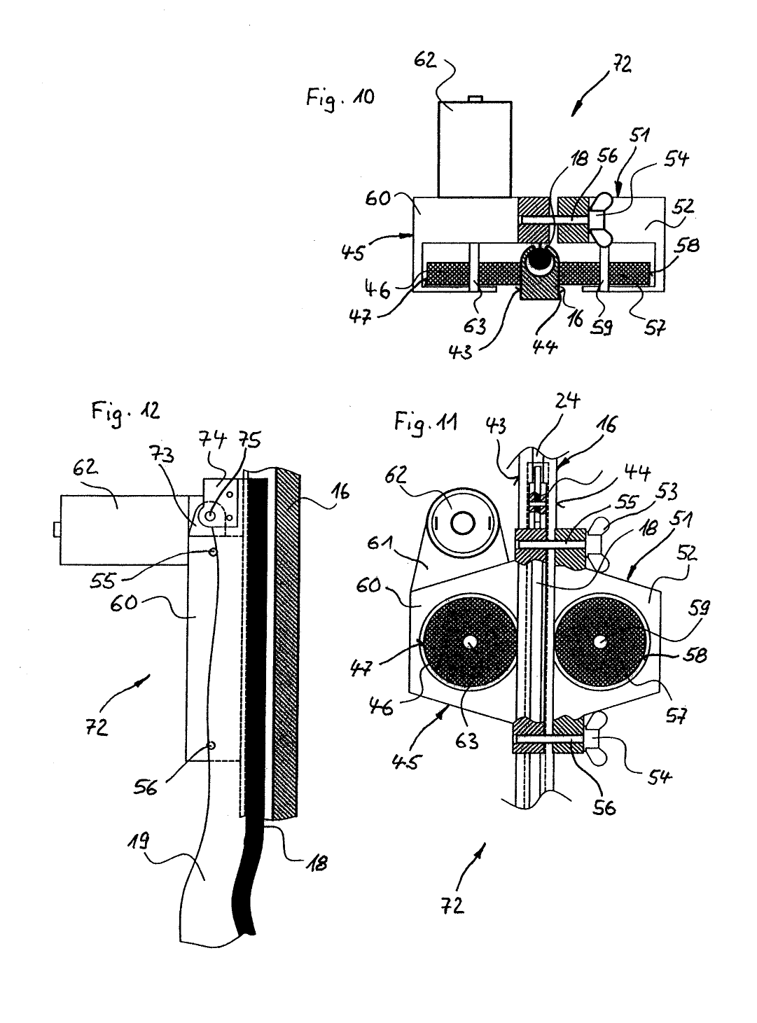

FIGS. 4 to 7 show the beginning of the installation of the awning 19 by means of the device 22. As recognizable in FIG. 4, the device 22 is connected with the awning 19 by engagement of the hook 40 with an eye 41 provided in the area of the end of the beading 18. The guiding element 31 is in its lowered position so that the end of the tie bolt 34 is extending only through the wing screw 35. So, the device 22 can easily pushed onto the awning rail 16 about its front end 20. This operation is shown in FIG. 5 and designated by the arrow. In the shown position, only the first part of the sliding body 25 is on the awning rail 16 with the guiding ball 33 inserted into the channel 23.

By further moving in the direction of this arrow, also the first guiding ball 30 of the guiding element 28 is inserted into the channel 23, so that the entire device 22 is now mounted onto the awning rail 16 as shown in FIG. 6. In this figure it is recognizable that a first part of the beading 18 is introduced into the channel 23 by pulling the awning 19 in the direction of the movement of device 22. Since there is only a lose contact between the awning rail 16 and the guiding balls 30, 33 and the driving wheel 26, the device 22 is not able to transmit enough driving forces from the motor 38 to the awning rail 16 for drawing the awning 19 along the awning rail 16.

For enhancing the frictional contact between driving wheel 26 and the outside of awning rail 16, the wing screw 35 is now turned as indicated by the arrow above it with the consequence that the tie bolt 34 and following the guiding element 31 is rised with respect to the sliding body 25. As explained above, the driving wheel 26 is moved in the direction of the outside of the awning rail 16 causing a pressing contact with the rolling surface 27, which is big enough to transmit the driving forces caused by the motor 38 to the contact between the driving wheel 26 and the awning rail 16 without slippage. This position is shown in FIG. 7. The device 22 is now in the condition to be moved along the awning rail 16 and thereby draw the awning 19 along the entire length of the awning rail 16.

Having reached the rear end 21 of the awning rail 16 (see FIG. 1), the connection between the device 22 and the awning 19 is disconnected and the device 22 is removed from the awning rail 16 about the opening at the rear end 21. For this operation it is recommended to lower the guiding element 31 by turning the wing screw 35 in a direction contrary to the direction indicated in FIG. 6.

For providing the motor 38 with electrical energy, the motor 38 can be connected via an electrical cable with the battery of the caravan 1, or a battery or accumulator can be located on the sliding body 25. Starting and stopping of the motor 38 can be affected by control signals from a remote control, which is operated by the person, who is installing the awning 19 by means of the device 22.

For removing the awning 19 from the caravan 1, the device 22 is mounted on the awning rail 16 about the opening at the rear end 21 of the awning rail 16. By actuating the motor 38 initiating a reversed turning direction, the device 22 is moved in an opposite direction along the awning rail 16 whereby the beading 18 is pushed in this direction as well so that the beading 18 leaves the opening of the awning rail 16 at its front end 20 gradually. This operation may be supported by the person by drawing the beading 18 out of the awning rail 16. Hence, the awning 19 can be removed from the caravan 1 in a similar manner as its installment described above.

FIGS. 8 and 9 show a second embodiment of a device 42 according to the present invention placed on the awning rail 16. It has a free channel 23 with a round cross-section and a small slot 24 extending in longitudinal direction of the awning rail 16 and constituting a C-profile with side walls 43, 44. The device 42 comprises a sliding body 45, wherein a driving wheel 46 is disposed having a cylindrical rolling surface 47 at its circumference. Also in this case, the driving wheel 46 consists of an elastomeric material like rubber, and its rolling surface 47 is in frictional contact with the outer surface of the awning rail 16, but in this embodiment in contact with the outer surface of its side wall 43.

In the middle of the sliding body 45 right above the awning rail 16, a single guiding element is projecting from the sliding body 45 through the slot 24 into the channel 23 of the awning rail 16. The guiding element 48 consists of a guide bar 49 guided by the edges of the awning rail 16 forming the slot 24 and of a guiding ball 50 that may be in contact with the inside of the awning rail 16 on both sides of the slot 24.

A pressing device 51 is disposed on the side of the awning rail 16 opposite to the sliding body 45. The pressing device 51 comprises a pressing body 52, which is connected with the sliding body 45 by wing screws 53, 54 at the front and the rear end of the device 42 respectively. The wing screws 53, 54 have screw bolts 55, 56, which are in screw connection with the sliding body 45.

A counter wheel 57 is disposed within the pressing body 52 having a cylindrical rolling surface 58 at its circumference. Also the counter wheel 57 consists of an elastomeric material like rubber. The counter wheel 57 is free rotatable about a rotation axis 59, which is directed perpendicular to the longitudinal axis of the awning rail 16 and also perpendicular to the axis 39 of the driving wheel 26 of the device 22 shown in FIGS. 1 to 7. The two wheels 46, 57 are disposed in the same plane.

The sliding body 45 comprises a gear box 60 having an extension 61, where an electrical motor 62 is fixed extending above the sliding body 45. The gear box 60 covers a gear connecting the driving axis of the motor 62 with a parallel axis 63 projecting from the gear box 60 downwards. This axis 63 has an extension parallel to the rotation axis 59 of the counter wheel 57 and is connected with the driving wheel 46 fixedly so that the driving force of the motor 62 is transmitted via the gear covered by the gear box 60 and the axis 63 to the driving wheel 46.

For installment of the device 42 at the awning rail 16, the wing screws 53, 54 are adjusted so that the driving wheel 46 and the counter wheel 57 have only loose contact with the side walls 43, 44 of the awning rail 16. Before actuating the motor 62, the wing screws 53, 54 are turned so that the distance between the rotation axis 59 of the counter wheel 57 and the axis 63 of the driving wheel 46 is reduced until the driving wheel 46 is pressed so much to the side wall 43 of the awning rail 16 that there is enough grip at this point for moving the device 42, when the awning 19 is connected with the device 42. Moving of the device 42 is caused by actuating the motor 62 for driving the driving wheel 46.

FIGS. 10 to 12 show another device 72 which differs only slightly from the device 42 shown in FIGS. 8 and 9. Hence, for the same parts and elements of both devices 42, 72, the same reference numbers are used, and for description of these parts of device 72, it is referred to the above description of device 42.

There are only two differences between device 72 and 42. The one difference is that device 72 does not comprise any specific guiding element like the guiding element 48. The second difference is that a fin 73 projects from the front end of the sliding body 45. This fin 73 is connected with a fin 74 by a connecting bolt 75, the fin 74 is fixed to the end of the awning 19 nearby the beading 18. The beading 18 extends in the channel 23 of the awning rail 16.

Moving the device 72 along the awning rail 16, the awning 19 and its beading 18 is moved therewith. The beading 18 forms a guiding element holding the device 72 in a position with respect to the awning rail 16 as shown in FIGS. 10 to 12, i.e. in a position, where the driving wheel 46 and the counter wheel 57 are pressed against the side walls 43, 44 respectively. Hence, no additional guiding element is necessary for that device 72.

Although a few embodiments of the present invention have been shown and described, it will be appreciated by those skilled in the art that changes may be made in these embodiments without departing from the principles and spirit of the invention, the scope of which is defined in the appended claims and their equivalents.

We claim:

1. Device (22, 42, 72) for assisting the installation and de-installation of an awning (19) at an awning rail (16) fixed on a wall (5) for example of a vehicle (1), the awning rail (16) having a C-profile with a slot (24) extending in its longitudinal direction and being destined for the reception of a beading (18) provided at an edge of the awning (19);
the device (22, 42, 72) has a connecting element (40, 73-75) for connection with the awning (19);
the device (22, 42, 72) has a motor (38, 62) for moving the edge of the awning (19) along the awning rail (16);
the motor (38, 62) is combined with a control system for starting and stopping the motor (38, 62);
characterized in that
the device (22, 42, 72) comprises a sliding body (25, 45) for sliding the device (22, 42, 72) along the awning rail (16) in a sliding direction;
the motor (38, 62) is located on or in the sliding body (25, 45);
a driving wheel (26, 46) is disposed on the sliding body (25, 45) with a rotation axis (39, 63) perpendicular to the sliding direction and is driven by the motor (38, 62);
the driving wheel (26, 46) is arranged so that it contacts the outside of the awning rail (16) when the device (22, 42, 72) is placed on the awning rail (16).

2. Device according to claim 1, characterized in that at least one guiding element (28, 31, 48) projects from the sliding body (25, 45) and is embodied so that the at least one guiding element (28, 31, 48) is partly insertible into the interior of the awning rail (16), the sliding body (25, 45) being outside the awning rail (16), particularly that the at least one guiding element (28, 31, 48) comprises at least one guiding wheel or guiding ball (30, 33, 50) being adapted to be inserted into the awning rail (16), especially that the rotation axis of the driving wheel (26, 46) and the rotation axis of the at least one guiding wheel or guiding ball (28, 31, 50) has parallel extensions.

3. Device according to claim 2, characterized in that the at least one guiding element (28, 31, 48) has a guiding bar (29, 32, 49) adapted to project through the slot (24) of the C-profile and extending between the sliding body (25, 45) and that part of the at least one guiding element (28, 31, 48) destined to be inserted into the awning rail (16).

4. Device according to claim 2, characterized in that at least two guiding elements (28, 31) are provided so that at least one guiding element (31) is located in sliding direction ahead of the driving wheel (26) and at least one behind the driving wheel (26).

5. Device according to claim 1, characterized in that the device (22, 42, 72) comprises a pressing device destined for enforcing the driving wheel (26, 46) in pressing contact with the outside of the awning rail (16).

6. Device according to claim 5, characterized in that the pressing device comprises an adjusting device enabling displacement of that part of the at least one guiding element (31) destined to be inserted into the awning rail (16) to and from the driving wheel (26) and/or for displacement of the driving wheel (26) to and from that part of the at least one guiding element (31) destined to be inserted into the awning rail (16).

7. Device according to claim 5, characterized in that the pressing device comprises a pressing body (52) having a counter wheel (57) with a rotation axis (59) extending parallel to the rotation axis (63) of the driving wheel (46) and that the two wheels (46, 57) extend in the same plane and are disposed so that their distance is adjustable by a pressing mechanism for pressing the two wheels (46, 47) towards opposite side walls (43, 44) of the awning rail (16), when the device (42, 72) is placed on the awning rail (16).

8. Device according to claim 7, characterized in that the connecting element (73) is located at a front end of the device (72) and/or the device (72) comprises a clamping mechanism for clamping the awning (19) nearby the beading (18).

9. Device according to claim 1, characterized in that the driving direction of the motor (38, 62) is reversible and/or the control system comprises a remote control enabling the control of the motor (38, 62) via wireless control signals.

10. Combination of an awning rail (16) with a device (22, 42, 72) according to claim 1 for the installation and de-installation of an awning (19), the awning rail (16) having a C-profile with a slot (24) extending in its longitudinal direction, the C-profile being destined for the reception of a beading (18) at an edge of the awning (19), wherein the device (22, 42, 72) is installable or installed at the awning rail (16) with the sliding body (25, 45) being outside of the awning rail (16) and the driving wheel (26, 46) being pressed against the outside of the awning rail (16).

11. Combination according to claim 10, characterized in that at least one guiding element (28, 31, 48) projects from the sliding body (25, 45) through the slot (24) of the awning rail (16) to its inside.

12. Combination according to claim 10, characterized in that the device (22, 42, 72) comprises a pressing device for enforcing the driving wheel (26, 46) into pressing contact with the awning rail (16).

13. Combination according to claim 11, characterized in that the pressing device is embodied as an adjusting device enabling to displace that part at the at least one guiding element (31) being inside of the awning rail (16) to and from the driving wheel (26) and/or to displace the driving wheel (26) to and from that part of the at least one guiding element (31) being inside of the awning rail (16).

14. Combination according to claim 12, characterized in that the pressing device comprises a pressing body (52) having a counter wheel (57) with a rotation axis (59) extending parallel to the rotation axis (63) of the driving wheel (46) and that the two wheels (46, 57) extend in the same plane and are disposed so that their distance is adjustable by a pressing mechanism for pressing the two wheels (46, 47) towards opposite side walls (43, 44) of the awning rail (16).

15. Caravan (1) provided with a combination according to claim 12.

16. Device according to claim 3, characterized in that at least two guiding elements (28, 31) are provided so that at least one guiding element (31) is located in sliding direction ahead of the driving wheel (26) and at least one behind the driving wheel (26).

17. Device according to claim 2, characterized in that the device (22, 42, 72) comprises a pressing device destined for enforcing the driving wheel (26, 46) in pressing contact with the outside of the awning rail (16).

18. Device according to claim 3, characterized in that the device (22, 42, 72) comprises a pressing device destined for enforcing the driving wheel (26, 46) in pressing contact with the outside of the awning rail (16).

19. Device according to claim 4, characterized in that the device (22, 42, 72) comprises a pressing device destined for enforcing the driving wheel (26, 46) in pressing contact with the outside of the awning rail (16).

20. Device according to claim 2, characterized in that the pressing device comprises an adjusting device enabling displacement of that part of the at least one guiding element (31) destined to be inserted into the awning rail (16) to and from the driving wheel (26) and/or for displacement of the driving wheel (26) to and from that part of the at least one guiding element (31) destined to be inserted into the awning rail (16).
